(19) United States
(12) Patent Application Publication
(10) Pub. No.: US 2026/0336068 A1
(43) Pub. Date: Oct. 29, 2026

(54) MAGNETIC WORKPIECE FIXTURE

(71) Applicant: EARTH-CHAIN ENTERPRISE CO., LTD., Taichung City (TW)

(72) Inventor: Mu-Chuan WANG, Taichung City (TW)

(21) Appl. No.: 19/252,144

(22) Filed: Jun. 27, 2025

(30) Foreign Application Priority Data
Apr. 25, 2025 (TW) 114115755

(51) Int. Cl. B25B 11/00

(52) U.S. Cl. CPC B25B 11/002

(57) ABSTRACT

A magnetic workpiece fixture is provided, comprising a magnetic worktable, a plurality of magnetic-elastic retention units, and a plurality of stationary retention posts. Each magnetic-elastic retention unit includes an upper repulsion magnet and a lower repulsion magnet disposed with a spacing therebetween, wherein adjacent sides of the upper and lower repulsion magnets have the same magnetic polarity to generate a repulsive force. The repulsive force allows each magnetic-elastic retention unit to produce an elastic restoring force in response to an external force. The magnetic workpiece fixture is thereby adaptable to secure workpieces having surfaces of varying profiles and dimensions, improving surface conformity and holding stability during machining operations.

### FIELD OF INVENTION

The present invention relates to a machining fixture, and more particularly to a magnetic workpiece fixture with an adjustable magnetic-elastic retention system.

### BACKGROUND OF THE INVENTION

In the metalworking industry, it is necessary to secure a workpiece in place during machining operations. Conventionally, a magnetic platform is employed to attract and hold the workpiece on the platform surface, thereby fixing the workpiece position. Unlike traditional mechanical fixtures, such a magnetic platform can accommodate workpieces of various sizes. However, when a surface of the workpiece is irregular or curved, the workpiece may fail to make full contact with the magnetic platform. As a result, the magnetic attraction between the workpiece and the magnetic platform may be insufficient, leading to displacement or deformation of the workpiece during machining.

### SUMMARY OF THE INVENTION

In view of the foregoing limitations of conventional fixtures, the present invention provides a magnetic workpiece fixture that is adaptable to workpieces having various surface profiles or sizes. The magnetic workpiece fixture comprises a magnetic worktable, a plurality of magnetic-elastic retention units, and a plurality of stationary retention posts. When a workpiece is placed on the magnetic workpiece fixture and a surface of the workpiece is uneven, the magnetic-elastic retention units enable the workpiece surface to conform to the magnetic workpiece fixture, thereby preventing displacement or deformation of the workpiece during machining.

Each of the plurality of magnetic-elastic retention units comprises an adjustable upper housing, a fixed lower housing, and a magnetic repulsion assembly disposed between the adjustable upper housing and the fixed lower housing. The magnetic repulsion assembly includes an upper repulsion magnet and a lower repulsion magnet. The upper repulsion magnet is threadably secured to the adjustable upper housing, and the lower repulsion magnet is threadably secured to the fixed lower housing. The upper repulsion magnet and the lower repulsion magnet have the same magnetic polarity on their adjacent sides, thereby generating a repulsive magnetic force. When an external force is applied to the magnetic-elastic retention unit, the adjustable upper housing and the fixed lower housing are displaced relative to each other, causing the magnetic-elastic retention unit to generate an elastic restoring force.

The magnetic workpiece fixture of the present invention offers the advantage of adaptively adjusting to an irregular surface of the workpiece through the use of the plurality of magnetic-elastic retention units, thereby ensuring conformal contact between the workpiece and the magnetic workpiece fixture. This prevents detachment or displacement that may otherwise result in deformation of the workpiece during machining. Additionally, since the magnetic repulsion assembly of each magnetic-elastic retention unit is composed of magnets rather than traditional springs, the issue of elastic fatigue is eliminated. Furthermore, when a magnetic polarity of the upper repulsion magnet that is coupled to the adjustable upper housing matches a magnetic polarity of a corresponding magnetic retention cell of the magnetic worktable, the magnetic force of the magnetic-elastic retention unit can be enhanced.

### BRIEF DESCRIPTION OF DRAWINGS

FIG. 1 is a schematic assembly diagram of the magnetic workpiece fixture according to a preferred embodiment of the present invention;

FIG. 2 is an exploded view of the magnetic-elastic retention unit according to the preferred embodiment;

FIG. 3 is a cross-sectional view of the magnetic-elastic retention unit in a first state according to the preferred embodiment;

FIG. 4 is a cross-sectional view of the magnetic-elastic retention unit in a second state according to the preferred embodiment; and

FIG. 5 is a schematic diagram of the magnetic workpiece fixture in use according to the preferred embodiment.

### DETAILED DESCRIPTION OF THE PREFERRED EMBODIMENTS

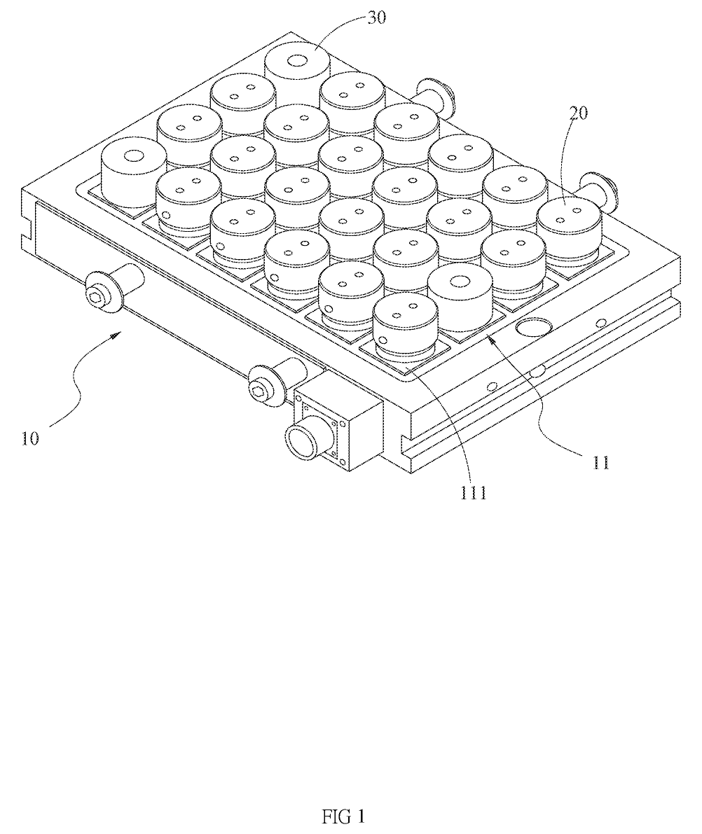

Referring to FIG. 1, a magnetic workpiece fixture according to a preferred embodiment of the present invention comprises a magnetic worktable 10, a plurality of magnetic-elastic retention units 20, and a plurality of stationary retention posts 30. The magnetic worktable 10 is configured as a rectangular body and includes a magnetic grid array 11 and a plurality of coils. The magnetic grid array 11 is disposed on a surface of the magnetic worktable 10 and is formed by an adjacent arrangement of a plurality of magnetic retention cells 111. Each of the magnetic retention cells 111 corresponds to one of the plurality of coils disposed within the magnetic worktable 10. When each of the coils is energized with electric current, a corresponding one of the magnetic retention cells 111 generates a magnetic field. By varying the direction of the current supplied to each of the coils, a magnetic polarity of each of the magnetic retention cells 111 can be selectively altered. The magnetic grid array 11 is further divided into groups of four magnetic retention cells 111, and in each group, at least one of the magnetic-elastic retention units 20 is disposed.

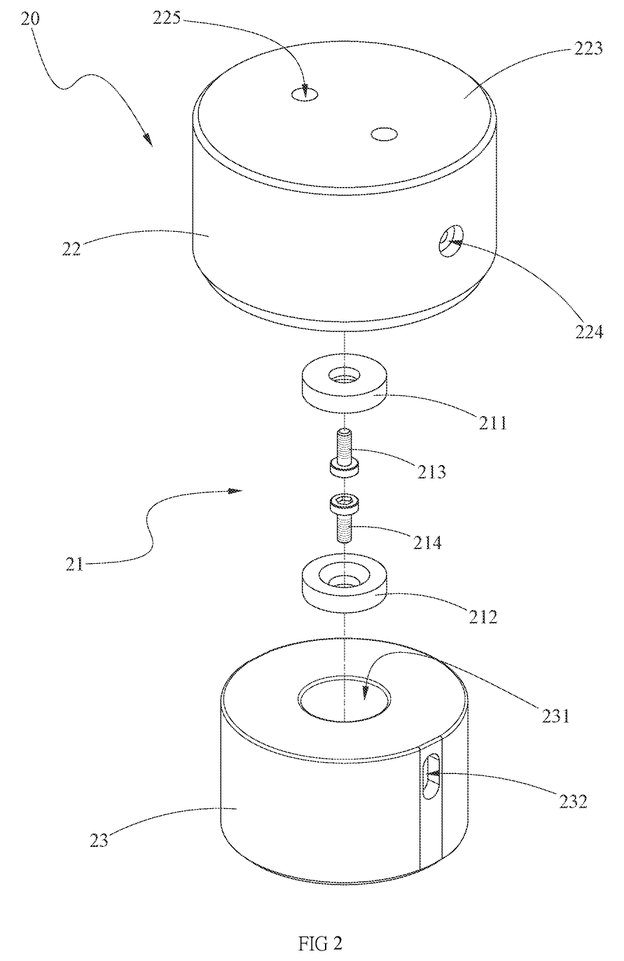

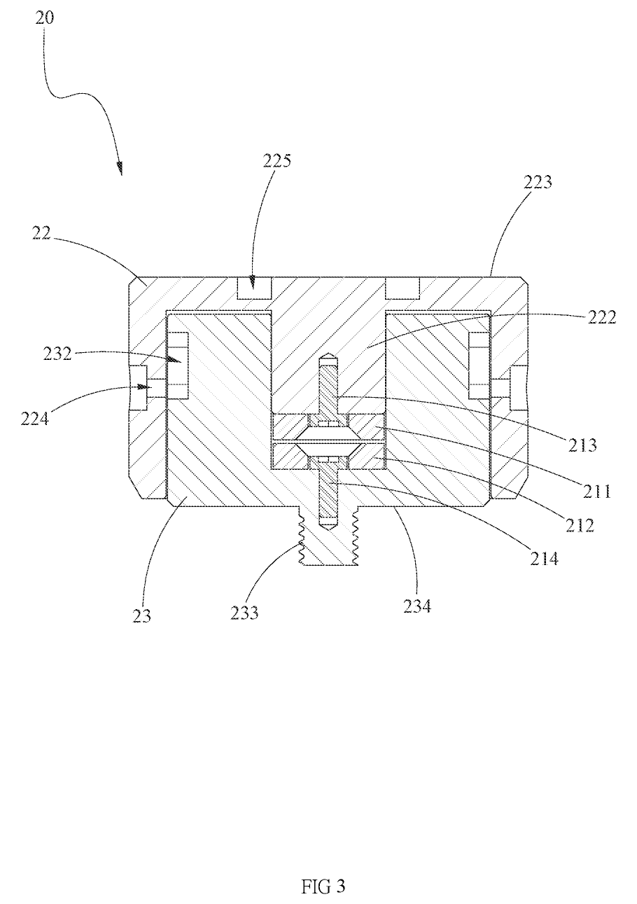

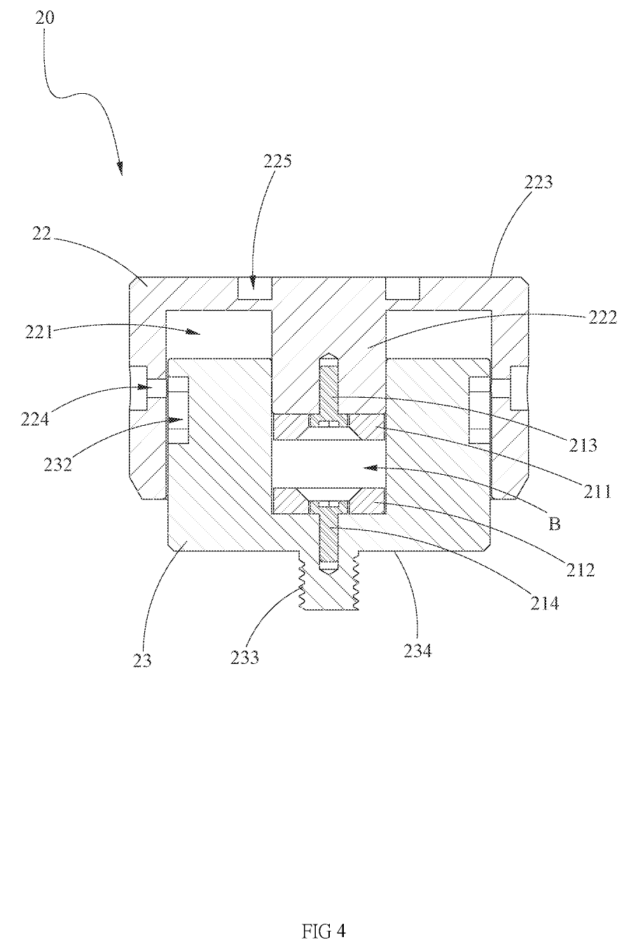

Referring to FIGS. 2 through 4, the magnetic-elastic retention unit 20 is configured as a cylindrical assembly and comprises a magnetic repulsion assembly 21, an adjustable upper housing 22, and a fixed lower housing 23. The magnetic repulsion assembly 21 includes an upper repulsion magnet 211, a lower repulsion magnet 212, an upper retention screw 213, and a lower retention screw 214. The upper repulsion magnet 211 and the lower repulsion magnet 212 are each formed as a ring-shaped permanent magnet having north (N) and south (S) poles. The upper repulsion magnet 211 and the lower repulsion magnet 212 are disposed with a spacing therebetween so as to define a repulsion gap B, with their mutually adjacent sides having the same magnetic polarity. The upper retention screw 213 extends through the upper repulsion magnet 211, and the lower retention screw 214 extends through the lower repulsion magnet 212.

The adjustable upper housing 22 is configured as a hollow cylindrical body and includes an interface aperture 221 at one end. The adjustable upper housing 22 further includes an axial alignment post 222, a pair of upper airflow ports 224, and a pair of workpiece anchor points 225. The axial alignment post 222 is configured to couple with the magnetic repulsion assembly 21 and protrudes from a closed end of the adjustable upper housing 22 toward the interface aperture 221. The upper retention screw 213 is threadably engaged with the axial alignment post 222 so as to secure the upper repulsion magnet 211 within the adjustable upper housing 22. The pair of upper airflow ports 224 extend through opposing sides of a circumferential surface of the adjustable upper housing 22. The pair of workpiece anchor points 225 are recessed into a workpiece engagement face 223 of the adjustable upper housing 22 and are configured to couple with a workpiece A.

The fixed lower housing 23 is also configured as a hollow cylindrical body and includes an alignment bore 231 at one end. The fixed lower housing 23 is inserted into the adjustable upper housing 22 through the alignment bore 231, which is aligned with the interface aperture 221. After assembly, the axial alignment post 222 extends into the fixed lower housing 23 through the alignment bore 231. The lower retention screw 214 is threadably engaged with a closed end of the fixed lower housing 23 to secure the lower repulsion magnet 212 within the fixed lower housing 23. When the axial alignment post 222 enters the fixed lower housing 23, the upper repulsion magnet 211 and the lower repulsion magnet 212 are axially aligned while remaining spaced apart. Because the adjacent sides of the upper repulsion magnet 211 and the lower repulsion magnet 212 have the same magnetic polarity, a repulsive magnetic force is generated, urging the adjustable upper housing 22 away from the fixed lower housing 23. When an external force is applied to the adjustable upper housing 22 in a direction toward the fixed lower housing 23, the applied external force counteracts the repulsive force, resulting in axial displacement that varies a size of the repulsion gap B and causes the magnetic-elastic retention unit 20 to generate an elastic restoring force. Accordingly, the adjustable upper housing 22 and the fixed lower housing 23 can move closer to or farther from each other depending on the balance between the repulsive magnetic force and the applied external force.

The fixed lower housing 23 includes a pair of lower airflow ports 232 and a fixture mounting stud 233. The pair of lower airflow ports 232 are recessed into opposing sides of a circumferential surface of the fixed lower housing 23. When the fixed lower housing 23 is assembled with the adjustable upper housing 22, the pair of lower airflow ports 232 are respectively aligned and in fluid communication with the pair of upper airflow ports 224 formed in the adjustable upper housing 22. Each of the lower airflow ports 232 is configured as an elongated slot extending in a direction toward the alignment bore 231, with a length greater than that of each of the upper airflow ports 224. During relative displacement of the adjustable upper housing 22 with respect to the fixed lower housing 23, each of the upper airflow ports 224 shifts along the length of a corresponding lower airflow port 232. Accordingly, during operation of the magnetic-elastic retention unit 20, as the fixed lower housing 23 and the adjustable upper housing 22 move toward or away from each other, gas can enter or exit through the interconnected upper airflow ports 224 and lower airflow ports 232. This airflow prevents the formation of vacuum pressure within the repulsion gap B, which could otherwise hinder the functionality of the magnetic-elastic retention unit 20. The increased length of the lower airflow ports 232 relative to the upper airflow ports 224 also ensures continuous fluid communication between the two sets of airflow ports throughout the full range of relative motion between the adjustable upper housing 22 and the fixed lower housing 23. In addition, the fixture mounting stud 233 axially protrudes from a grid mounting face 234 of the fixed lower housing 23 and is configured to be threadably engaged with the magnetic worktable 10.

Each of the plurality of stationary retention posts 30 is configured as a cylindrical body and is disposed within a respective one of the magnetic retention cells 111 of the magnetic grid array 11 on the magnetic worktable 10. When the workpiece A is placed on the magnetic workpiece fixture, magnetic force generated by the corresponding magnetic retention cell 111 produces an attractive force between the workpiece A and the magnetic workpiece fixture.

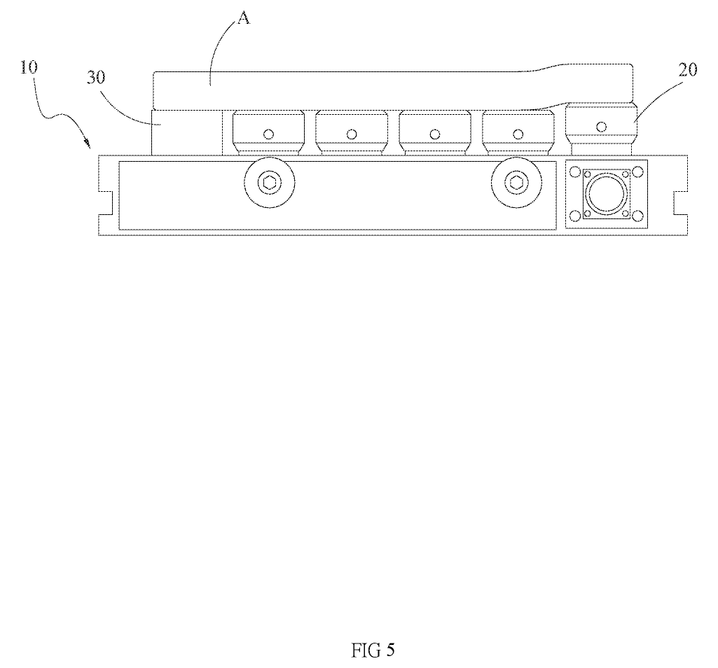

Referring to FIG. 5, the magnetic workpiece fixture provided by the present invention utilizes magnetic attraction in combination with the structural arrangement of the plurality of magnetic-elastic retention units 20 to conformably and securely engage a surface of a workpiece A. For example, when the surface of the workpiece A includes a recessed portion, one of the magnetic-elastic retention units 20 may be positioned in alignment with the recessed portion when the workpiece A is placed on the magnetic worktable 10. At that time, the repulsive magnetic force generated between the upper repulsion magnet 211 and the lower repulsion magnet 212 causes the adjustable upper housing 22 of the magnetic-elastic retention unit 20 to move away from the fixed lower housing 23, thereby extending the adjustable upper housing 22 until it contacts the recessed portion on the surface of the workpiece A. Concurrently, the magnetic attraction generated between the workpiece A and the magnetic workpiece fixture stably holds the workpiece A in place, thereby ensuring close contact between the workpiece A and the magnetic workpiece fixture and preventing detachment or displacement that could otherwise lead to deformation of the workpiece A during or after machining. Because the magnetic repulsion assembly 21 of each magnetic-elastic retention unit 20 is composed of magnets rather than conventional mechanical springs, each magnetic-elastic retention unit 20 is not subject to elastic fatigue. Accordingly, the magnetic workpiece fixture provided by the present invention is capable of adaptively conforming to variations in the surface profile of the workpiece A. This prevents the formation of any gaps between an irregular surface of the workpiece A and the magnetic workpiece fixture that would otherwise reduce the effectiveness of magnetic adhesion.

More specifically, when the magnetic polarity of the magnetic retention cell 111, in which the magnetic-elastic retention unit 20 is disposed, is the same as the magnetic polarity of the side of the upper repulsion magnet 211 that is coupled to the adjustable upper housing 22, the magnetic force generated by the magnetic-elastic retention unit 20 can be increased. For example, if the magnetic polarity of the magnetic retention cell 111 is north (N), and the magnetic polarity of the side of the upper repulsion magnet 211 facing the magnetic retention cell 111 is also north (N), this configuration enhances the overall magnetic force of the magnetic-elastic retention unit 20 due to like-pole reinforcement.

The present invention provides distinct advantages in accommodating irregular surface contours of the workpiece A. Through the deployment of the plurality of magnetic-elastic retention units 20, the surface of the magnetic workpiece fixture may be adaptively adjusted to ensure conformal contact with the surface of the workpiece A. This prevents detachment or displacement of the workpiece A and avoids post-machining deformation. Since the magnetic repulsion assembly 21 within each magnetic-elastic retention unit 20 is composed of magnets, rather than conventional mechanical springs, issues related to elastic fatigue are eliminated. Furthermore, when the magnetic polarity of the side of the upper repulsion magnet 211 that is coupled to the adjustable upper housing 22 corresponds to the magnetic polarity of the magnetic retention cell 111 in which the magnetic-elastic retention unit 20 is positioned, the magnetic force of the magnetic-elastic retention unit 20 is further increased, thereby enhancing the overall holding capability of the magnetic workpiece fixture.

What is claimed is:

1. A magnetic workpiece fixture, comprising:
a magnetic worktable comprising a magnetic grid array and a plurality of coils, wherein the magnetic grid array is disposed on a surface of the magnetic worktable and is formed by a plurality of adjacent magnetic retention cells, each of the plurality of adjacent magnetic retention cells corresponding to a respective one of the plurality of coils, such that when the plurality of coils is energized with current, a magnetic field is generated in each of the plurality of adjacent magnetic retention cells; and
at least one magnetic-elastic retention unit disposed in one of the plurality of adjacent magnetic retention cells, the at least one magnetic-elastic retention unit comprising:
an upper repulsion magnet and a lower repulsion magnet spaced apart from each other such that a repulsion gap is defined therebetween, wherein adjacent sides of the upper repulsion magnet and the lower repulsion magnet have a same magnetic polarity such that a repulsive force is generated therebetween, and
wherein the lower repulsion magnet is disposed proximate to the one of the magnetic retention cells, and a size of the repulsion gap is variable based on an external force applied to the upper repulsion magnet in a direction toward the lower repulsion magnet.

2. The magnetic workpiece fixture of claim 1, wherein the magnetic-elastic retention unit further comprises:
an adjustable upper housing coupled to the upper repulsion magnet; and
a fixed lower housing coupled to the lower repulsion magnet,
wherein the adjustable upper housing is movable relative to the fixed lower housing in response to the external force such that the adjustable upper housing moves toward or away from the fixed lower housing.

3. The magnetic workpiece fixture of claim 2, wherein the magnetic-elastic retention unit further comprises:
an upper retention screw and a lower retention screw,
wherein the upper repulsion magnet and the lower repulsion magnet are each formed as a ring-shaped magnet,
wherein the upper retention screw extends through the upper repulsion magnet and is coupled to the adjustable upper housing, and
wherein the lower retention screw extends through the lower repulsion magnet and is coupled to the fixed lower housing.

4. The magnetic workpiece fixture of claim 3, wherein the adjustable upper housing comprises:
an interface aperture at one end; and
an axial alignment post protruding from a closed end of the adjustable upper housing toward the interface aperture,
wherein the upper retention screw is threadably engaged with the axial alignment post to fix the upper repulsion magnet within the adjustable upper housing.

5. The magnetic workpiece fixture of claim 3, wherein the fixed lower housing comprises:
an alignment bore at one end,
wherein the alignment bore is aligned with the interface aperture and the fixed lower housing is inserted into the adjustable upper housing through the alignment bore,
wherein, after assembly, the axial alignment post extends into the fixed lower housing through the alignment bore.

6. The magnetic workpiece fixture of claim 2, wherein:
the adjustable upper housing comprises a pair of upper airflow ports extending through opposing sides of a circumferential surface thereof; and
the fixed lower housing comprises a pair of lower airflow ports recessed into opposing sides of a circumferential surface thereof,
wherein the pair of lower airflow ports are aligned with the pair of upper airflow ports after assembly.

7. The magnetic workpiece fixture of claim 6, wherein each of the pair of lower airflow ports is configured as an elongated slot extending in a direction toward the alignment bore and has a length greater than a length of each of the pair of upper airflow ports.

8. The magnetic workpiece fixture of claim 2, wherein the fixed lower housing further comprises:
a fixture mounting stud protruding axially from a grid mounting face thereof,
wherein the fixture mounting stud is configured to be threadably engaged with the magnetic worktable.
